(19) United States
(12) Patent Application Publication
(10) Pub. No.: US 2026/0128643 A1
(43) Pub. Date: May 7, 2026

(54) ROTATING ELECTRIC MACHINE SYSTEM

(71) Applicant: HONDA MOTOR CO., LTD., Tokyo (JP)

(72) Inventors: Tsubasa Nakatomi, Wako-shi (JP); Tatsuya Choji, Wako-shi (JP)

(21) Appl. No.: 19/372,546

(22) Filed: Oct. 29, 2025

(30) Foreign Application Priority Data
Nov. 1, 2024 (JP) 2024-192804

(51) Int. Cl. H02K 7/08; H02K 1/2706; H02K 1/32

(52) U.S. Cl. CPC H02K 7/083; H02K 1/2706; H02K 1/32

(57) ABSTRACT

In a rotating electric machine system, a rotor internal flow path that allows a liquid coolant to flow is formed in an interior of a rotor. At least one portion of a rotor internal flow path is formed between an outer peripheral surface of a rotating shaft and an inner peripheral surface of a sleeve. A support member being adjacent to an inner ring of a first bearing and configured to support a first sleeve end part is disposed between a first bearing and the sleeve. The sleeve is formed seamlessly from between the rotating shaft and permanent magnets, to the first sleeve end part that is supported by the support member.

### CROSS-REFERENCE TO RELATED APPLICATIONS

This application is based upon and claims the benefit of priority from Japanese Patent Application No. 2024-192804 filed on November 1, 2024, the contents of which are incorporated herein by reference.

### BACKGROUND OF THE INVENTION

### FIELD OF THE INVENTION

The present disclosure relates to a rotating electric machine system.

### DESCRIPTION OF THE RELATED ART

A rotary electric machine includes a rotor having a rotating shaft, and a stator that is positioned on an outer circumference of the rotor. The rotor includes permanent magnets that are retained on the rotating shaft. When the rotating shaft rotates, an induced electrical current is generated in an electromagnetic coil that makes up the stator. In this case, the rotating electric machine functions as a generator. When the temperature of the permanent magnets becomes too high during the operation of the rotating electric machine, the magnetic force of the permanent magnets decreases. For example, in JP 2011-097784 A, in order to cool the permanent magnets, a configuration is disclosed in which a cooling medium (oil) is supplied to the interior of the rotating shaft.

### SUMMARY OF THE INVENTION

It is undesirable for the cooling medium to leak out from any location other than a normal discharge outlet.

The present invention has the object of solving the aforementioned problem.

An aspect of the present disclosure is characterized by a rotating electric machine system, including a rotating electric machine including a rotor, the rotor including a permanent magnet and a rotating shaft, a rotating electric machine housing configured to rotatably support the rotating shaft, and a first bearing and a second bearing each interposed between the rotating electric machine housing and the rotating shaft, and configured to be spaced apart from each other in an axial direction of the rotor, wherein a rotor internal flow path through which a liquid coolant is allowed to flow is formed in an interior of the rotor, the rotor further includes a sleeve interposed between the rotating shaft and the permanent magnet in a radial direction of the rotating shaft, and at least a portion of the rotor internal flow path is formed between an outer peripheral surface of the rotating shaft and an inner peripheral surface of the sleeve, a support member that is adjacent to an inner ring of the first bearing and configured to support a first sleeve end part, which is one end part of the sleeve, is disposed between the first bearing and the sleeve, and the sleeve is configured to be formed seamlessly from between the rotating shaft and the permanent magnet to the first sleeve end part that is supported by the support member.

In accordance with the rotating electric machine system according to the present disclosure, since there are no seams from between the rotating shaft and the permanent magnet to the first sleeve end part that is supported by the support member, the number of locations where leakage of the liquid coolant is capable of occurring is reduced. In accordance therewith, since leakage of the liquid coolant from any location other than the outlet of the rotor internal flow path can be suppressed, it is possible to suppress a situation in which an area inside the rotating electric machine housing into which the liquid coolant is not intended to flow becomes contaminated by the liquid coolant.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a combined motive power system;

FIG. 2 is a schematic cross-sectional view of a rotating electric machine system;

FIG. 3 is a schematic cross-sectional view of the rotating electric machine system as viewed from another angle;

FIG. 4 is an enlarged cross-sectional view in the vicinity of a first bearing; and

FIG. 5 is an enlarged cross-sectional view in the vicinity of a second bearing.

### DETAILED DESCRIPTION OF THE INVENTION

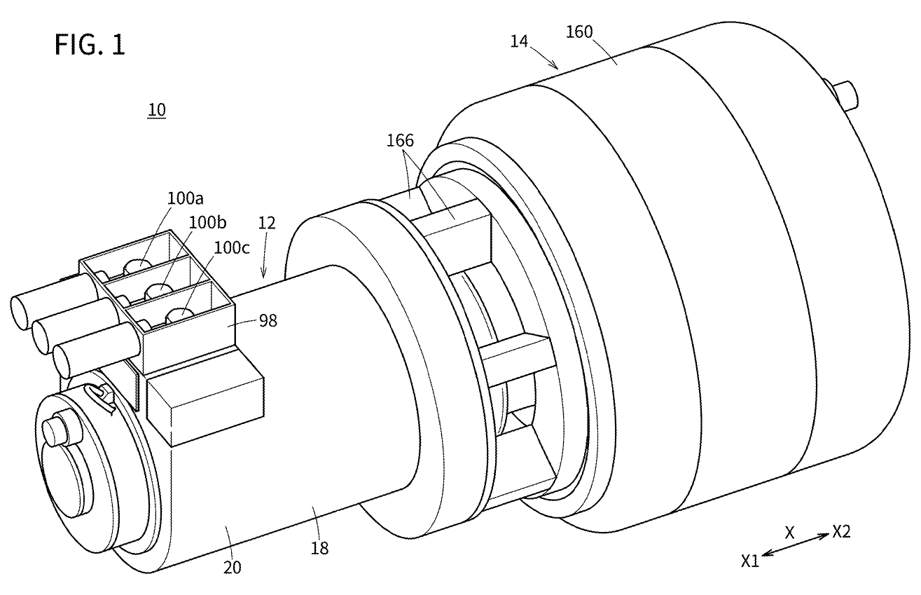

A combined motive power system 10 shown in FIG. 1 includes a rotating electric machine system 12 according to the present embodiment, and a gas turbine engine 14. An axial line of the rotating electric machine system 12 and an axial line of the gas turbine engine 14 coincide with each other. Stated otherwise, the rotating electric machine system 12 and the gas turbine engine 14 are disposed in series on the same axial line.

The combined motive power system 10 is used, for example, as a motive power source for providing propulsion in a flying object, a ship, an automobile, or the like. Suitable specific examples of the flying object include a drone and a multi-copter. The combined motive power system 10, when mounted on a flying object, is used as a power drive source for rotating, for example, a prop, a ducted fan, or the like. The combined motive power system 10, when mounted on a ship, is used as a screw rotational force generating device. The combined motive power system 10, when mounted on an automobile, is used as a power drive source for rotating a motor.

The combined motive power system 10 can also be used as an auxiliary power source in an aircraft, a ship, a building, or the like. Apart therefrom, it is also possible to utilize the combined motive power system 10 as gas turbine power generation equipment. The gas turbine engine 14 is an internal combustion engine.

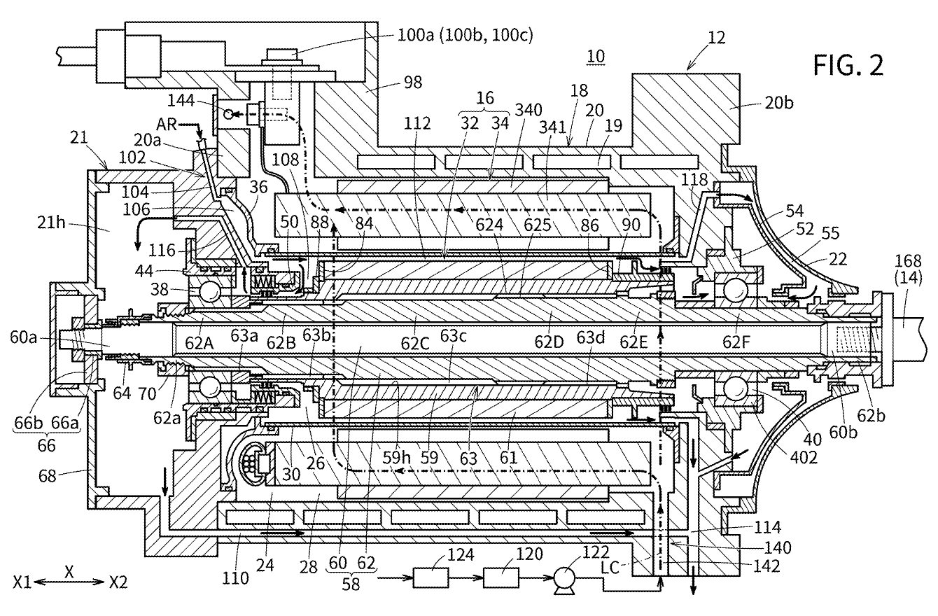

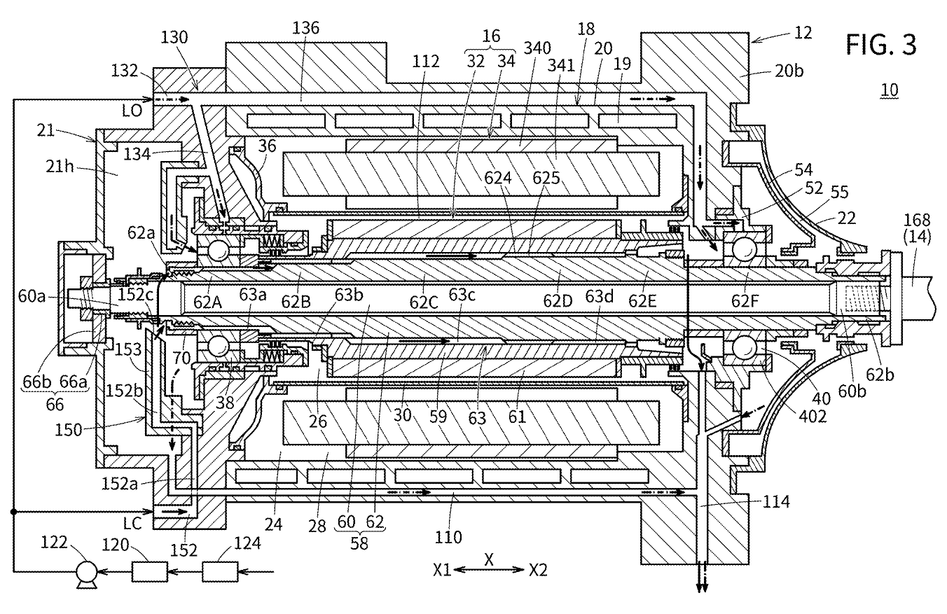

In the following description, the respective terms "lower" and "upper" refer specifically to relative vertical positions shown in FIG. 2 and FIG. 3. However, these directions are provided for the sake of convenience in order to simplify the description and facilitate understanding. In particular, the directions described in the specification do not necessarily correspond to the actual orientation of the combined motive power system 10 during use.

As shown in FIG. 2, the rotating electric machine system 12 includes a rotating electric machine 16 and a rotating electric machine housing 18. In the present embodiment, the rotating electric machine 16 is a generator.

The rotating electric machine housing 18 serves to accommodate the rotating electric machine 16. The rotating electric machine housing 18 includes a main housing 20, a first sub-housing 21, and a second sub-housing 22. The main housing 20 has a generally cylindrical shape in which both ends thereof are open. A cooling jacket 19 is formed in the interior of a peripheral wall part of the main housing 20. A liquid coolant such as cooling water or the like flows through the cooling jacket 19.

The main housing 20 includes a main storage chamber 24. A hollow cylindrically shaped partition wall member 30 is disposed in the main storage chamber 24. The main storage chamber 24 is divided by the partition wall member 30 into a rotor chamber 26 and a stator chamber 28. The rotor chamber 26 is a chamber that is formed more inwardly in a radial direction than the partition wall member 30. The stator chamber 28 is a chamber that is formed more outwardly in the radial direction than the partition wall member 30.

The rotating electric machine 16 includes a rotor 32 and a stator 34. The rotor 32 is accommodated in the rotor chamber 26. The stator 34 is accommodated in the stator chamber 28, and surrounds the outer periphery of the rotor 32. An end part of the partition wall member 30 on a side in an X1 direction is inserted into an inner peripheral part of a partition member 36 that is retained by the first sub-housing 21 in the main storage chamber 24.

The first sub-housing 21 is connected to a first housing end 20a, which is an end part of the main housing 20 on a side in the X1 direction, and closes the opening of the first housing end 20a. The second sub-housing 22 is connected to a second housing end 20b, which is an end part of the main housing 20 on a side in the X2 direction, and closes the opening of the second housing end 20b.

The rotor 32 is supported, via a first bearing 38 and a second bearing 40, to be capable of rotating with respect to the rotating electric machine housing 18. Thus, next, a description will be given concerning the first bearing 38, the second bearing 40, and structures in the vicinity thereof.

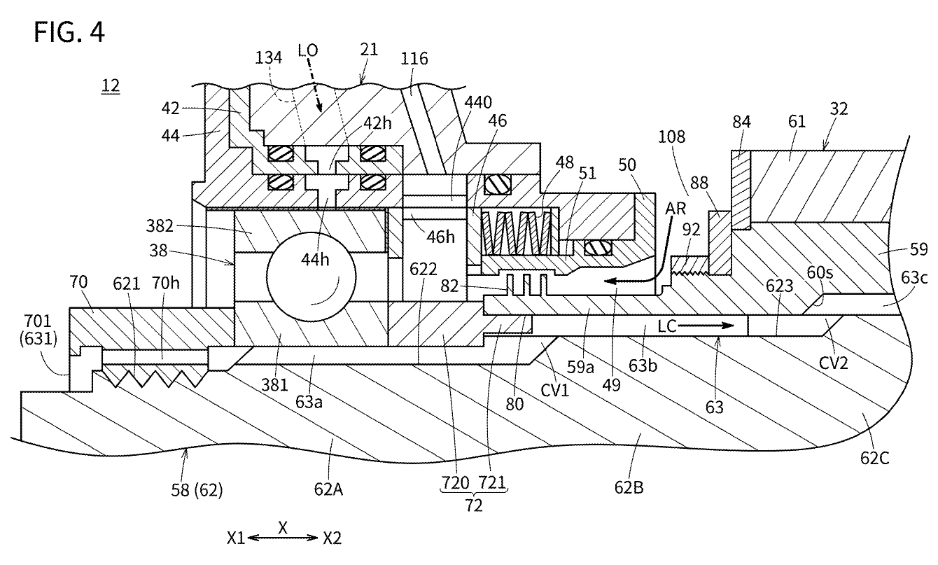

As shown in FIG. 4, a hollow cylindrically shaped holder spacer 42 and a hollow cylindrically shaped first bearing holder 44 are inserted into an inner peripheral part of the first sub-housing 21. The first bearing 38 is disposed on an inner side of the first bearing holder 44. A lubricating oil LO is supplied to the first bearing 38, via an oil supplying hole 42h that is formed in the holder spacer 42, and an oil supplying hole 44h that is formed in the first bearing holder 44.

The first bearing holder 44 includes a plurality of oil drainage holes 440. The plurality of oil drainage holes 440 are holes for the purpose of discharging the lubricating oil LO that was supplied to the first bearing 38 to the exterior of the first bearing holder 44.

A spacer ring 46 is positioned and fixed inside an interior of the first bearing holder 44. The spacer ring 46 has a plurality of relay holes 46h. The plurality of relay holes 46h are formed at intervals in the circumferential direction of the spacer ring 46.

A preload applying member 48 applies a load (a preload), via the spacer ring 46, to an outer ring 382 of the first bearing 38. A direction of the load is an axial direction (an X direction) of the rotor 32. The preload applying member 48 is constituted, for example, by a plurality of disc springs.

A holder member 50 is mounted on an end part of the first bearing holder 44 on a side in the X2 direction. The holder member 50 is fixed to the first bearing holder 44, and therefore, is a non-rotating part. The holder member 50 retains the preload applying member 48. The holder member 50 includes a hollow cylindrically shaped holder tubular part 51. The preload applying member 48 is disposed in an annular shaped space that is formed between the first bearing holder 44 and the holder tubular part 51.

As shown in FIG. 2, an annular shaped second bearing holder 52 is mounted on the second housing end 20b (an end part on a side in the X2 direction) of the main housing 20. The second bearing holder 52 is connected via bolts or the like to the main housing 20. An outer ring 402 of the second bearing 40 is retained on an inner peripheral part of the second bearing holder 52.

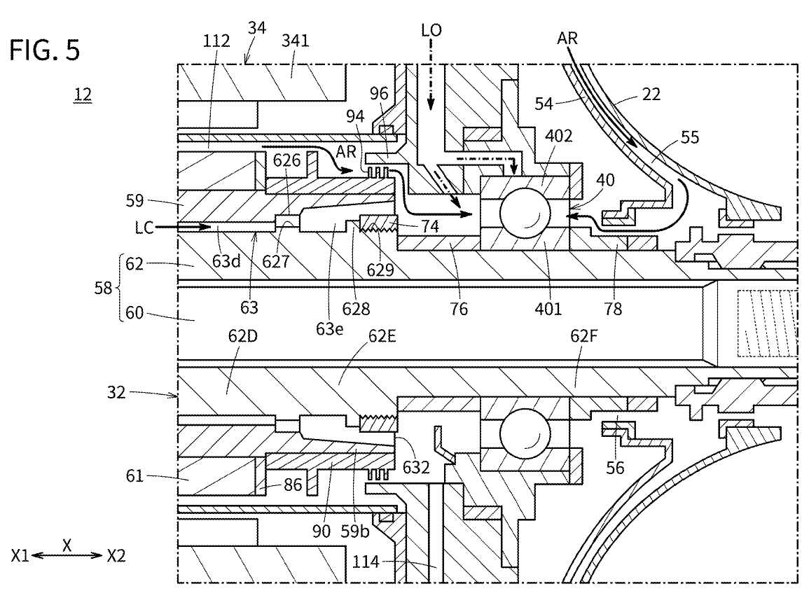

The rotor 32 includes a rotating shaft 58, a sleeve 59, and permanent magnets 61. The sleeve 59 surrounds the rotating shaft 58, and the permanent magnets 61 surround the sleeve 59. A rotor internal flow path 63 is formed in the interior of the rotor 32. According to the present embodiment, the cooling oil flows as a liquid coolant LC through the rotor internal flow path 63. The liquid coolant LC flows through the rotor internal flow path 63 from an inlet 631 (refer to FIG. 4) of the rotor internal flow path 63 toward an outlet 632 (refer to FIG. 5) thereof. More specifically, the liquid coolant LC flows in the X2 direction through the rotor internal flow path 63. Therefore, concerning the rotor internal flow path 63, the side in the X1 direction is an upstream side, and the side in the X2 direction is a downstream side. The rotor internal flow path 63 gradually expands in diameter in a stepwise manner toward the downstream side.

The rotating shaft 58 is rotatably supported via the first bearing 38 by the first sub-housing 21, and is rotatably supported via the second bearing 40 by the main housing 20. The rotating shaft 58 includes an inner shaft 60, and an outer shaft 62.

The inner shaft 60 includes a first inner shaft end 60a which is an end part on a side in the X1 direction, and a second inner shaft end 60b which is an end part on a side in the X2 direction. The outer shaft 62 includes a first outer shaft end 62a which is an end part on a side in the X1 direction, and a second outer shaft end 62b which is an end part on a side in the X2 direction. The inner shaft 60 is inserted into the interior of the outer shaft 62. The inner shaft 60 is longer than the outer shaft 62.

The first inner shaft end 60a projects out in the X1 direction from the first outer shaft end 62a. The first inner shaft end 60a is connected to the first outer shaft end 62a by a fastening structure including a nut member 64 or the like.

A resolver rotor 66a is fixed to the first inner shaft end 60a. A resolver stator 66b is disposed in a manner so as to surround the resolver rotor 66a. The resolver stator 66b is retained by a resolver holder 68 that is mounted in the first sub-housing 21. A resolver 66 is constituted by the resolver rotor 66a and the resolver stator 66b.

The outer shaft 62 is a hollow cylindrically shaped member. The outer shaft 62 includes a first shaft portion 62A to a sixth shaft portion 62F. The first outer shaft end 62a is disposed on the first shaft portion 62A.

As shown in FIG. 4, the first shaft portion 62A, between a fastening ring 70, the first bearing 38, and a support member 72, forms a first flow through space 63a of the rotor internal flow path 63. The first flow through space 63a allows the liquid coolant LC to flow inwardly in a radial direction of the first bearing 38. An inner ring 381 of the first bearing 38 is supported by the first shaft portion 62A. An outer peripheral part of the first shaft portion 62A includes a male thread 621, and a plurality of flow path grooves 622.

The fastening ring 70 is screw-engaged with the male thread 621 of the first shaft portion 62A. The inner ring 381 of the first bearing 38 is sandwiched, in the axial direction (the X direction) of the rotor 32, between the fastening ring 70 and the support member 72. The support member 72 is an inner ring stopper. In accordance therewith, the inner ring 381 of the first bearing 38 is fixed at a predetermined location on the outer peripheral surface of the outer shaft 62.

The fastening ring 70 includes a plurality of communication holes 70h that are formed at intervals from one another in the circumferential direction. The plurality of communication holes 70h pass through an inner peripheral part of the fastening ring 70 in the axial direction. An annular shaped opening 701, which is disposed on a side in the X1 direction of the fastening ring 70, serves as the inlet 631 of the rotor internal flow path 63. An end surface of the fastening ring 70 on a side in the X2 direction abuts against the inner ring 381 of the first bearing 38. The plurality of communication holes 70h form one portion of the rotor internal flow path 63.

The plurality of flow path grooves 622 are disposed on a more downstream side than the plurality of communication holes 70h that are formed in the fastening ring 70. The plurality of flow path grooves 622 are formed at intervals from one another in the circumferential direction of the outer shaft 62. Each of the flow path grooves 622 is recessed inwardly in the radial direction from the outer peripheral surface of the outer shaft 62, and extends in the axial direction of the rotor 32. The plurality of flow path grooves 622 constitute one portion of the rotor internal flow path 63. The inner ring 381 of the first bearing 38 is disposed in a manner so as to surround the plurality of flow path grooves 622. An area from upstream ends of the communication holes 70h of the fastening ring 70 to downstream ends of the flow path grooves 622 is the first flow through space 63a.

The support member 72 is an annular shaped member that is disposed between the inner ring 381 of the first bearing 38 and the sleeve 59. The support member 72, for example, is fixed to the outer shaft 62 by press fitting. The support member 72 is supported by an outer peripheral part of the first shaft portion 62A. The support member 72 is disposed in a manner so as to surround the plurality of flow path grooves 622. The support member 72 is adjacent to the inner ring 381 of the first bearing 38, and further, supports a first sleeve end part 59a which is one end part of the sleeve 59.

The support member 72 includes a supporting base part 720 and a supporting tubular part 721. The supporting base part 720 is a portion of the support member 72 that is adjacent to the first bearing 38. The supporting tubular part 721 projects out in the X2 direction from the supporting base part 720 along the axial direction of the rotor 32. An outer peripheral surface of the supporting tubular part 721 supports an inner peripheral surface of the first sleeve end part 59a. An inner peripheral surface of the supporting tubular part 721 constitutes one portion of the rotor internal flow path 63.

A second shaft portion 62B is disposed at a position adjacent to a side in the X2 direction of the first shaft portion 62A. The second shaft portion 62B forms a second flow through space 63b of the rotor internal flow path 63 between itself and the sleeve 59. The second flow through space 63b is an annular shaped space that extends in the axial direction of the rotor 32 on a more downstream side than the first flow through space 63a. The second flow through space 63b is positioned more outwardly in the radial direction than the first flow through space 63a. Therefore, the second flow through space 63b allows the liquid coolant LC to flow more outwardly in the radial direction than the first flow through space 63a.

The rotor internal flow path 63 includes a direction changing portion CV1 between the first flow through space 63a and the second flow through space 63b. Hereinafter, the direction changing portion CV1 will also be referred to as a "first direction changing portion CV1". The first direction changing portion CV1 connects the first flow through space 63a and the second flow through space 63b, and serves to direct the liquid coolant LC outwardly in the radial direction. A centrifugal force acts on the rotating shaft 58. By the centrifugal force, the liquid coolant LC is guided along the first direction changing portion CV1 from the first flow through space 63a to the second flow through space 63b. The supporting tubular part 721 forms one portion of the first direction changing portion CV1 and one portion of the first flow through space 63a. A range from an end surface of the support member 72 on a side in the X2 direction to an upstream end of later-described first relay flow path grooves 623 is the second flow through space 63b.

A third shaft portion 62C is disposed at a position adjacent to a side in the X2 direction of the second shaft portion 62B. The third shaft portion 62C forms a third flow through space 63c between itself and the sleeve 59. The third flow through space 63c is an annular shaped space that extends in the axial direction of the rotor 32 on a more downstream side than the second flow through space 63b. The third flow through space 63c is positioned more outwardly in the radial direction than the second flow through space 63b. Therefore, the third flow through space 63c allows the liquid coolant LC to flow more outwardly in the radial direction than the second flow through space 63b.

A plurality of the first relay flow path grooves 623 are formed on an outer peripheral part of an end part of the third shaft portion 62C on a side in the X1 direction. The plurality of first relay flow path grooves 623 connect to each other the second flow through space 63b and the third flow through space 63c. The plurality of first relay flow path grooves 623 are formed at intervals from one another in the circumferential direction of the outer shaft 62. Each of the first relay flow path grooves 623 is recessed inwardly in the radial direction from the outer peripheral surface of the outer shaft 62, and extends in the axial direction (the X direction) of the rotor 32. The plurality of first relay flow path grooves 623 constitute one portion of the rotor internal flow path 63. A range from a step 60s disposed on an inner surface of the sleeve 59 to upstream ends of later-described second relay flow path grooves 625 (refer to FIG. 2) forms the third flow through space 63c.

The rotor internal flow path 63 includes a direction changing portion CV2 between the second flow through space 63b and the third flow through space 63c. Hereinafter, the direction changing portion CV2 will also be referred to as a "second direction changing portion CV2". The second direction changing portion CV2 connects the second flow through space 63b and the third flow through space 63c, and serves to direct the liquid coolant LC outwardly in the radial direction. By the centrifugal force generated by the rotation of the rotating shaft 58, the liquid coolant LC is guided along the second direction changing portion CV2 from the second flow through space 63b to the third flow through space 63c.

As shown in FIG. 2, a fourth shaft portion 62D is disposed at a position adjacent to a side in the X2 direction of the third shaft portion 62C. An outer diameter of the fourth shaft portion 62D is slightly larger than the outer diameter of the third shaft portion 62C. The fourth shaft portion 62D forms a fourth flow through space 63d between itself and the sleeve 59. The fourth flow through space 63d is an annular shaped space that extends in the axial direction of the rotor 32 on a more downstream side than the third flow through space 63c.

A plurality of ribs 624 are formed at intervals from one another in the circumferential direction on an outer peripheral part of an end part of the fourth shaft portion 62D on a side in the X1 direction. The plurality of ribs 624 project outwardly in the radial direction from an outer peripheral surface of the fourth shaft portion 62D. The plurality of second relay flow path grooves 625 are formed between the plurality of ribs 624. The plurality of second relay flow path grooves 625 connect to each other the third flow through space 63c and the fourth flow through space 63d. Each of the second relay flow path grooves 625 extends in the axial direction (the X direction) of the rotating shaft 58. The plurality of second relay flow path grooves 625 constitute one portion of the rotor internal flow path 63. A range from downstream ends of the second relay flow path grooves 625 to upstream ends of later-described communication passages 627 (see FIG. 5) is the fourth flow through space 63d.

As shown in FIG. 5, a fifth shaft portion 62E is disposed at a position adjacent to a side in the X2 direction of the fourth shaft portion 62D. The fifth shaft portion 62E forms an outlet space 63e of the rotor internal flow path 63 between itself and the sleeve 59. The outlet space 63e is an annular shaped space that is formed between the fifth shaft portion 62E and the sleeve 59. An outer peripheral part of the fifth shaft portion 62E includes a plurality of ribs 626, a flange portion 628, and a male thread 629.

The plurality of ribs 626 are formed at intervals from one another in the circumferential direction of the fifth shaft portion 62E. The plurality of communication passages 627 are formed between the plurality of ribs 626. The plurality of communication passages 627 connect the fourth flow through space 63d and the outlet space 63e. Therefore, the plurality of communication passages 627 form one portion of the rotor internal flow path 63. The flange portion 628 and the male thread 629 are disposed more on a downstream side than the plurality of communication passages 627. A nut 74, together with abutting against the flange portion 628, is threaded onto the male thread 629.

The sixth shaft portion 62F is disposed at a position adjacent to a side in the X2 direction of the fifth shaft portion 62E. The outer diameter of the sixth shaft portion 62F is smaller than the outer diameter of the fifth shaft portion 62E. An inner side inner ring stopper 76, an inner ring 401 of the second bearing 40, and an outer side inner ring stopper 78 are supported by an outer peripheral surface of the sixth shaft portion 62F. The inner ring 401 of the second bearing 40 is sandwiched from both sides in the axial direction between the inner side inner ring stopper 76 and the outer side inner ring stopper 78. In accordance therewith, the inner ring 401 of the second bearing 40 is fixed at a predetermined location on the outer peripheral surface of the outer shaft 62.

As shown in FIG. 2, the sleeve 59 is a hollow cylindrically shaped member having an inner hole 59h. The rotating shaft 58 is inserted into the inner hole 59h of the sleeve 59. Most of the rotor internal flow path 63 is formed by the sleeve 59 and the rotating shaft 58. The sleeve 59 covers the third shaft portion 62C and the fourth shaft portion 62D of the rotating shaft 58. The sleeve 59 includes the first sleeve end part 59a (refer to FIG. 4), which is an end part on a side in the X1 direction, and a second sleeve end part 59b (refer to FIG. 5), which is an end part on a side in the X2 direction.

As shown in FIG. 4, the sleeve 59 is formed seamlessly from between the rotating shaft 58 and the permanent magnets 61, to the first sleeve end part 59a that is supported by the support member 72. More specifically, a projecting member of the sleeve 59 that is projected out in the X1 direction from the permanent magnets 61 is not a structure in which a plurality of parts are joined together, but is a continuous single part (an integrally molded member).

The supporting tubular part 721 of the support member 72 is inserted into the first sleeve end part 59a. The supporting tubular part 721 is fixed to the first sleeve end part 59a, for example, by press fitting. Therefore, the inner peripheral surface of the first sleeve end part 59a and the outer peripheral surface of the supporting tubular part 721 form a fitting portion 80 and are in close contact with each other over the entire circumference in the circumferential direction. A seal member 82 is disposed on an outer peripheral part of the first sleeve end part 59a. The seal member 82 is a labyrinth seal having a plurality of projections that are spaced apart from one another in the axial direction.

The holder member 50 is a hollow cylindrically shaped portion that is disposed outwardly in a radial direction of the first sleeve end part 59a. Therefore, the holder member 50 faces toward the seal member 82 in the radial direction, and surrounds the seal member 82. A gap is formed between the seal member 82 and the holder member 50 (the holder tubular part 51). The preload applying member 48 is disposed in a manner so as to surround the holder member 50, the seal member 82, and the supporting tubular part 721. The first sleeve end part 59a is inserted into an inner side of the holder member 50. An annular gap 49 is formed between the first sleeve end part 59a and the holder member 50.

The sleeve 59 is fixed, for example, by shrink fitting, to an outer surface of the rotating shaft 58. According to the present embodiment, the sleeve 59 is shrink fitted at respective positions between an end part of the third shaft portion 62C on a side in the X1 direction, and the plurality of ribs 626 that are disposed on the fifth shaft portion 62E.

The permanent magnets 61 are retained in the sleeve 59. In the present aspect, the rotor 32 is a so-called SPM (surface permanent magnet motor) type in which the permanent magnets 61 are disposed on the outer peripheral surface of the sleeve 59. Alternatively, the rotor 32 may be of a so-called IPM (interior permanent magnet motor) type in which the permanent magnets 61 are embedded in the sleeve 59.

As shown in FIG. 2, a first ring body 84 abuts against end surfaces of the permanent magnets 61 on a side in the X1 direction. A second ring body 86 abuts against end surfaces of the permanent magnets 61 on a side in the X2 direction. The first ring body 84, the permanent magnets 61, and the second ring body 86, in the axial direction of the rotor 32, are sandwiched by a pair of magnet stoppers 88 and 90. Hereinafter, the magnet stopper 88 on the side in the X1 direction will be referred to as a "first magnet stopper 88", and the magnet stopper 90 on the side in the X2 direction will be referred to as a "second magnet stopper 90".

The first magnet stopper 88 is fixed by a fixing ring 92 (refer to FIG. 4) that is screwed onto the sleeve 59. The second magnet stopper 90 is fixed to the second sleeve end part 59b. The first magnet stopper 88 and the second magnet stopper 90 are fixed, for example, by shrink fitting, to an outer peripheral part of the sleeve 59. In accordance therewith, the permanent magnets 61 are fixed to an outer peripheral surface of the sleeve 59.

As shown in FIG. 5, a seal member 94 is disposed on an outer peripheral part of the second magnet stopper 90. The seal member 94 is a labyrinth seal having a plurality of projections that are spaced apart from one another in the axial direction. The seal member 94 faces in a radial direction on an annular shaped projection 96 that is disposed on the main housing 20. A gap is formed between the seal member 94 and the annular shaped projection 96.

The second sleeve end part 59b forms the outlet space 63e of the rotor internal flow path 63 between itself and the fifth shaft portion 62E of the outer shaft 62. An inner diameter of the second sleeve end part 59b that forms the outlet space 63e is larger than an inner diameter of a portion of the sleeve 59 that forms the fourth flow through space 63d.

An inner diameter of the second sleeve end part 59b becomes larger in the X2 direction. By a centrifugal force generated by the rotation of the rotating shaft 58, the liquid coolant LC flows from the fourth flow through space 63d to the outlet space 63e. A downstream end of the outlet space 63e (an opening of the sleeve 59 on a side in the X2 direction) is the outlet 632 of the rotor internal flow path 63. The sleeve 59 is formed seamlessly from between the rotating shaft 58 and the permanent magnets 61, to an end surface of the second sleeve end part 59b in the X2 direction.

As shown in FIG. 2, the stator 34 includes a stator core 340, and a plurality of electromagnetic coils 341. The stator core 340 is a cylindrically shaped member. The stator core 340 is constituted, for example, by laminating a plurality of ring-shaped electromagnetic steel plates in the axial direction. A plurality of slots are formed in the stator core 340. Teeth portions are formed between adjacent ones of the slots.

The plurality of electromagnetic coils 341 are a U-phase coil, a V-phase coil, and a W-phase coil. Therefore, in the case that the rotating electric machine 16 is a generator, the rotating electric machine 16 is a so-called three-phase electrical power source. Each of the plurality of electromagnetic coils 341 is constituted by winding a conductive wire around teeth portions of the stator core 340.

As shown in FIG. 1, a terminal casing 98 is integrally disposed on an upper surface on a side in the X1 direction of the main housing 20. As shown in FIG. 2, a U-phase terminal 100a, a V-phase terminal 100b, and a W-phase terminal 100c are accommodated inside the terminal casing 98. The U-phase terminal 100a, the V-phase terminal 100b, and the W-phase terminal 100c are electrically connected respectively to the U-phase coil, the V-phase coil, and the W-phase coil of the stator 34.

An air cooling structure 102 is further provided in the rotating electric machine system 12. The air cooling structure 102 is a structure for the purpose of cooling the rotor 32 (particularly, the permanent magnets 61) with a gaseous coolant. In the following description, compressed air AR will be exemplified as the gaseous coolant. The compressed air AR is supplied, for example, from the gas turbine engine 14.

The air cooling structure 102 includes an intake air passage 104, a relay air passage 106, a first branching passage 108, a first drain passage 110, a second branching passage 112, and a second drain passage 114. An air intake port, which serves as an inlet to the intake air passage 104, is disposed on an outer surface of the first sub-housing 21. The first branching passage 108 and the second branching passage 112 are one portion of the rotor chamber 26. The second drain passage 114 serves in a dual manner as an oil discharge passage and a gaseous coolant discharge passage.

The intake air passage 104 is formed in the first sub-housing 21. The compressed air AR that has passed through the intake air passage 104 flows into the relay air passage 106. The relay air passage 106 is a space that is formed between the first sub-housing 21 and the partition member 36. The compressed air AR that has passed through the relay air passage 106 flows into the rotor chamber 26. The compressed air AR that has flowed into the rotor chamber 26 is divided into the first branching passage 108 and the second branching passage 112.

The first branching passage 108 is a flow path that serves to direct the compressed air AR toward the first bearing 38. As shown in FIG. 4, the compressed air AR that has passed through the first branching passage 108 flows into the annular gap 49 that is formed between the holder member 50 and the sleeve 59, and flows in the X1 direction through this annular gap 49. The compressed air AR that flows in this manner toward the first bearing 38 forms an air curtain. Thereafter, the compressed air AR flows, via the relay holes 46h that are disposed in the spacer ring 46, into a flow path 116 that is formed in the first sub-housing 21. As shown in FIG. 2, the compressed air AR that has passed through the flow path 116 flows, via a hollow portion 21h of the first sub-housing 21, into the first drain passage 110.

The second branching passage 112 is a clearance that extends along the axial direction of the rotor 32 between the permanent magnets 61 and the partition wall member 30. The second branching passage 112 is a flow path that serves to direct the compressed air AR toward the second bearing 40. As shown in FIG. 5, a portion of the compressed air AR that has passed through the second branching passage 112 flows into a side on the outer periphery of the inner side inner ring stopper 76, and is directed toward the second bearing 40. The compressed air AR that flows in this manner toward the second bearing 40 forms an air curtain.

As shown in FIG. 2, the remainder of the compressed air AR that has passed through the second branching passage 112 flows into an air distribution passage 118 that is formed in the main housing 20. The compressed air AR that has passed through the air distribution passage 118 flows into a flow path 55 that is formed between the second sub-housing 22 and a flow path forming member 54. An outer peripheral part of the flow path forming member 54 is fixed to the main housing 20 on an inner side of the second sub-housing 22. As shown in FIG. 5, an annular shaped ventilation passage 56 is formed between an inner peripheral part of the flow path forming member 54 and an outer peripheral part of the outer side inner ring stopper 78. The compressed air AR that has passed through the flow path 55 is directed, via the flow path 55 and the ventilation passage 56, toward the second bearing 40.

As shown in FIG. 2, the second drain passage 114 extends downwardly in the interior of the main housing 20. The first drain passage 110 merges with the second drain passage 114. The second drain passage 114 extends to the outer surface of the rotating electric machine housing 18. The compressed air AR that is discharged from the second drain passage 114 is recovered in a gas/liquid separation device 120. The compressed air AR from which the oil has been separated is discharged from the gas/liquid separation device 120 into the atmosphere.

As shown in FIG. 3, a lubricating oil flow path structure 130 is further disposed in the rotating electric machine system 12. The lubricating oil flow path structure 130 is a flow path in order to supply the lubricating oil LO to the first bearing 38 and the second bearing 40.

The lubricating oil flow path structure 130 includes a lubricating oil introduction passage 132, a first distribution passage 134, the first drain passage 110, a second distribution passage 136, and the second drain passage 114. The lubricating oil introduction passage 132 is formed in an upper part of the first sub-housing 21 in FIG. 2. In FIG. 3, the lubricating oil LO is supplied by a circulation pump 122 to the lubricating oil introduction passage 132. The lubricating oil introduction passage 132, in the interior of the first sub-housing 21, branches into the first distribution passage 134 and the second distribution passage 136.

The first distribution passage 134 is formed in the first sub-housing 21. The lubricating oil LO is supplied via the first distribution passage 134 to the first bearing 38. The lubricating oil LO that is supplied to the first bearing 38, after having passed through the first drain passage 110, flows out via the second drain passage 114 to the exterior of the rotating electric machine housing 18. Moreover, as noted previously, an air curtain is formed by the compressed air AR in proximity to the first bearing 38. Therefore, a situation in which the lubricating oil LO that is supplied to the first bearing 38 enters via the annular gap 49 (refer to FIG. 4) into the rotor chamber 26 is suppressed.

The second distribution passage 136 is formed in the main housing 20. The lubricating oil LO is supplied via the second distribution passage 136 to the second bearing 40. The lubricating oil LO that is supplied to the second bearing 40 flows out via the second drain passage 114 to the exterior of the rotating electric machine housing 18. The lubricating oil LO that is discharged from the second drain passage 114, after having been separated into a gas and a liquid by the gas/liquid separation device 120, is stored in a tank 124. Moreover, as noted previously, an air curtain is formed by the compressed air AR in proximity to the second bearing 40. Therefore, a situation in which the lubricating oil LO that is supplied to the second bearing 40 enters into the rotor chamber 26 is suppressed.

As shown in FIG. 2, a stator cooling structure 140 is further disposed in the rotating electric machine system 12. The stator cooling structure 140 is a flow path in order to circulate and supply the liquid coolant LC into the stator chamber 28, and thereby cool the stator 34. The liquid coolant LC that is supplied to the stator chamber 28, for example, is a cooling oil (the lubricating oil LO). Moreover, the liquid coolant LC that is supplied to the stator chamber 28 may be an organic solvent with a high boiling point and low volatility.

The stator cooling structure 140 includes an introduction flow passage 142, the stator chamber 28, and a stator chamber side drain passage 144. The introduction flow passage 142 is provided at an end part of the main housing 20 on a side in the X2 direction. The stator chamber side drain passage 144 is disposed in the terminal casing 98.

The liquid coolant LC is supplied by the circulation pump 122 to the introduction flow passage 142. The liquid coolant LC is supplied via the introduction flow passage 142 to the stator chamber 28. The liquid coolant LC that has passed through the stator chamber 28 is discharged, via the stator chamber side drain passage 144, to the exterior of the rotating electric machine housing 18. The liquid coolant LC that has been discharged is recovered by the tank 124 via the gas/liquid separation device 120, and is supplied again to the introduction flow passage 142 by the circulation pump 122. Moreover, although the stator cooling structure 140 is configured to cool the stator 34 by using the liquid coolant LC, instead of such a structure, a structure may be adopted in which the stator 34 is cooled using a gaseous coolant (the compressed air AR). In this case, the partition wall member 30 is not necessary.

As shown in FIG. 3, a rotor cooling structure 150 is disposed in the rotating electric machine system 12. The rotor cooling structure 150 is a flow path in order to supply the liquid coolant LC into the rotor 32, and thereby cool the permanent magnets 61. The liquid coolant LC that is supplied into the rotor 32, for example, is a cooling oil (the lubricating oil LO). Moreover, the liquid coolant LC that is supplied into the rotor 32 may be an organic solvent with a high boiling point and low volatility.

The rotor cooling structure 150 includes a supply passage 152, the aforementioned rotor internal flow path 63, and the second drain passage 114. The supply passage 152 supplies the liquid coolant LC to the rotor internal flow path 63. The supply passage 152 includes an introduction passage 152a that is formed in the first sub-housing 21, and a guide passage 152b that is formed in a nozzle member 153. The liquid coolant LC is supplied by the circulation pump 122 to the introduction passage 152a.

The guide passage 152b communicates with the introduction passage 152a. The nozzle member 153 is disposed in the hollow portion 21h of the first sub-housing 21, and is fixed to the first sub-housing 21. A discharge port 152c, which is the outlet of the guide passage 152b, faces toward the inlet 631 (see FIG. 4) of the rotor internal flow path 63. The liquid coolant LC that is discharged from the discharge port 152c, as shown in FIG. 4, flows via the annular shaped opening 701 (the inlet 631) of the fastening ring 70 into the rotor internal flow path 63.

As shown in FIG. 3, the second drain passage 114 discharges to the exterior of the rotating electric machine housing 18 the liquid coolant LC that has flowed out from the rotor internal flow path 63. The liquid coolant LC that has been discharged is recovered by the tank 124 via the gas/liquid separation device 120, and is supplied again to the supply passage 152 by the circulation pump 122.

Next, a description will be given concerning the gas turbine engine 14 shown in FIG. 1. Moreover, it should be noted that the configuration of the gas turbine engine 14, for example, is similar to the configuration shown in FIG. 7 of JP 2023-106078 A. Therefore, the description of the gas turbine engine 14 will be kept brief.

The gas turbine engine 14 is equipped with an engine housing 160. The engine housing 160 is connected to the rotating electric machine housing 18. The engine housing 160 includes a plurality of leg members 166. An air intake space is formed between the leg members 166.

As shown in FIG. 2, the gas turbine engine 14 includes an output shaft 168. A non-illustrated compressor wheel and a non-illustrated turbine wheel are mounted outwardly in a radial direction of the output shaft 168. The output shaft 168 is connected to the rotating shaft 58. The compressor wheel and the turbine wheel are capable of rotating integrally together with the rotating shaft 58 and the output shaft 168.

The gas turbine engine 14 is a gaseous coolant supply device that supplies the compressed air AR. A portion of the compressed air AR that is generated by the rotation of the compressor wheel is extracted, and is supplied to the intake air passage 104 that is disposed in the first sub-housing 21. Moreover, the gaseous coolant that is supplied to the intake air passage 104 may be the compressed air AR that is obtained by compressing atmospheric air using another compressor. The gaseous coolant that is supplied to the intake air passage 104 may be a gas supplied from an oxygen cylinder, a nitrogen cylinder, or the like.

The present embodiment possesses the following advantageous effects.

As shown in FIG. 4, in the sleeve 59, since there are no seams from between the rotating shaft 58 and the permanent magnets 61 to the first sleeve end part 59a that is supported by the support member 72, the number of locations where leakage of the liquid coolant LC is capable of occurring is reduced. In accordance therewith, leakage of the liquid coolant LC from any location other than the outlet 632 (refer to FIG. 5) of the rotor internal flow path 63 can be suppressed. Therefore, it is possible to suppress a situation in which an area (the rotor chamber 26 or the like) inside the rotating electric machine housing 18 into which the liquid coolant LC is not intended to flow becomes contaminated by the liquid coolant LC.

As shown in FIG. 4, an outer peripheral surface of the supporting tubular part 721 that is disposed on the support member 72 supports an inner peripheral surface of the first sleeve end part 59a of the sleeve 59. In accordance with such a configuration, the supporting tubular part 721 of the support member 72 is capable of suitably supporting the first sleeve end part 59a.

An inner peripheral surface of the supporting tubular part 721 forms one portion of the rotor internal flow path 63. In accordance with such a configuration, since the supporting tubular part 721 serves in a dual manner the function of one portion of the rotor internal flow path 63 and the function of supporting the first sleeve end part 59a of the sleeve 59, rationalization through simplification of the structure is achieved.

The holder member 50 is disposed outwardly in a radial direction of the first sleeve end part 59a. The seal member 82 that faces in the radial direction toward the holder member 50 is disposed on the outer peripheral part of the first sleeve end part 59a. In accordance with such a configuration, the seal member 82 can more effectively suppress leakage of the liquid coolant LC.

An outer peripheral surface of the supporting tubular part 721 of the support member 72 supports an inner peripheral surface of the first sleeve end part 59a. The preload applying member 48, which applies a load to the outer ring 382 of the first bearing 38, is disposed in a manner so as to surround the holder member 50, the seal member 82, and the supporting tubular part 721. In accordance with such a configuration, since the holder member 50, the seal member 82, the supporting tubular part 721, and the preload applying member 48 are all disposed in the vicinity of the first bearing 38, rationalization through simplification of the structure can be achieved.

The support member 72 and the rotating shaft 58 are fixed to each other by press fitting, and the support member 72 and the sleeve 59 are fixed to each other by press fitting. In accordance with such a configuration, the rotating shaft 58, the sleeve 59, and the support member 72 can be fixed to one another.

The sleeve 59, together with being shrink-fitted onto the outer surface of the rotating shaft 58, is also shrink-fitted onto the first magnet stopper 88 and the second magnet stopper 90 (refer to FIG. 5) that serve to fix the permanent magnets 61. In accordance with such a configuration, since the permanent magnets 61 can be suitably fixed to the sleeve 59, the permanent magnets 61 can be prevented from flying off.

The following supplementary notes are further disclosed in relation to the above-described embodiments.

### Supplemental Note 1

The rotating electric machine system (12) according to the present disclosure is equipped with the rotating electric machine (16) including the rotor (32), the rotor including the permanent magnet (61) and the rotating shaft (58), the rotating electric machine housing (18) configured to rotatably support the rotating shaft, and the first bearing (38) and the second bearing (40) each interposed between the rotating electric machine housing and the rotating shaft, and configured to be spaced apart from each other in the axial direction of the rotor, wherein the rotor internal flow path (63) through which the liquid coolant (LC) is allowed to flow is formed in the interior of the rotor, the rotor further includes the sleeve (59) interposed between the rotating shaft and the permanent magnet in the radial direction of the rotating shaft, and at least the portion of the rotor internal flow path is formed between the outer peripheral surface of the rotating shaft and the inner peripheral surface of the sleeve, the support member (72) that is adjacent to the inner ring (381) of the first bearing and configured to support the first sleeve end part (59a), which is one end part of the sleeve, is disposed between the first bearing and the sleeve, and the sleeve is configured to be formed seamlessly from between the rotating shaft and the permanent magnet to the first sleeve end part that is supported by the support member. In accordance with such a configuration, since there are no seams from between the rotating shaft and the permanent magnet to the first sleeve end part that is supported by the support member, the number of locations where leakage of the liquid coolant LC is capable of occurring is reduced. In accordance therewith, since leakage of the liquid coolant from any location other than the outlet of the rotor internal flow path can be suppressed, it is possible to suppress a situation in which an area inside the rotating electric machine housing into which the liquid coolant is not intended to flow becomes contaminated by the liquid coolant.

### Supplementary Note 2

In the rotating electric machine system according to Supplementary Note 1, the support member may include the supporting base part (720) that is adjacent to the first bearing, and the supporting tubular part (721) configured to project out from the supporting base part along the axial direction of the rotating shaft, and the outer peripheral surface of the supporting tubular part may support the inner peripheral surface of the first sleeve end part of the sleeve. In accordance with such a configuration, the supporting tubular part of the support member is capable of suitably supporting the first sleeve end part.

### Supplementary Note 3

In the rotating electric machine system according to Supplementary Note 1 or 2, the inner peripheral surface of the supporting tubular part forms one portion of the rotor internal flow path. In accordance with such a configuration, since the supporting tubular part serves in a dual manner the function of one portion of the rotor internal flow path and the function of supporting the first sleeve end part of the sleeve, simplification of the structure is achieved.

### Supplementary Note 4

In the rotating electric machine system according to any one of Supplementary Notes 1 to 3, the holder member (50) having the hollow tubular shape and configured to surround the first sleeve end part may be disposed outwardly of the first sleeve end part in the radial direction, and the seal member (82) configured to face in the radial direction toward the holder member is disposed on the outer peripheral part of the first sleeve end part. In accordance with such a configuration, the seal member can more effectively suppress leakage of the liquid coolant.

### Supplementary Note 5

In the rotating electric machine system according to Supplementary Note 4, the support member may include the supporting base part that is adjacent to the first bearing, and the supporting tubular part configured to project out from the supporting base part along the axial direction of the rotating shaft, the outer peripheral surface of the supporting tubular part may support the inner peripheral surface of the first sleeve end part of the sleeve, and the preload applying member (48) configured to apply the load to the outer ring (382) of the first bearing may be disposed in the manner so as to surround the holder member, the seal member, and the supporting tubular part. In accordance with such a configuration, the holder member, the seal member, the supporting tubular part, and the preload applying member are collectively disposed in the vicinity of the first bearing, and thus the rationalization of the structure can be achieved.

### Supplementary Note 6

In the rotating electric machine system according to any one of Supplementary Notes 1 to 5, the support member and the rotating shaft may be fixed to each other by press fitting, and the support member and the sleeve may be fixed to each other by press fitting. In accordance with such a configuration, the rotating shaft, the sleeve, and the support member can be fixed to one another.

### Supplementary Note 7

In the rotating electric machine system according to any one of Supplementary Notes 1 to 6, the sleeve may be shrink-fitted onto the outer surface of the rotating shaft, and be also shrink-fitted onto the magnet stopper (88, 90) configured to fix the permanent magnet. In accordance with such a configuration, since the permanent magnets can be suitably fixed to the sleeve, the permanent magnet can be prevented from flying off.

Although the present disclosure has been described in detail, the present disclosure is not necessarily limited to the specific embodiments described above. These embodiments can be subjected to various additions, substitutions, modifications, partial deletions, and the like, within a range that does not depart from the essence and gist of the present disclosure, or alternatively, the purpose and gist of the present disclosure as derived from the contents described in the claims and their equivalents. Further, these embodiments can also be implemented in combination. For example, in the above-described embodiments, the order of the operations and the order of the processes are shown merely as examples, and the present invention is not necessarily limited to these examples. Further, the same also applies to cases in which numerical values or mathematical expressions are used in the description of the aforementioned embodiments.

1. A rotating electric machine system, comprising:
a rotating electric machine including a rotor, the rotor including a permanent magnet and a rotating shaft;
a rotating electric machine housing configured to rotatably support the rotating shaft; and
a first bearing and a second bearing each interposed between the rotating electric machine housing and the rotating shaft, and configured to be spaced apart from each other in an axial direction of the rotor;
wherein a rotor internal flow path through which a liquid coolant is allowed to flow is formed in an interior of the rotor;
the rotor further includes a sleeve interposed between the rotating shaft and the permanent magnet in a radial direction of the rotating shaft, and at least a portion of the rotor internal flow path is formed between an outer peripheral surface of the rotating shaft and an inner peripheral surface of the sleeve;
a support member that is adjacent to an inner ring of the first bearing and configured to support a first sleeve end part, which is one end part of the sleeve, is disposed between the first bearing and the sleeve; and
the sleeve is configured to be formed seamlessly from between the rotating shaft and the permanent magnet to the first sleeve end part that is supported by the support member.

2. The rotating electric machine system according to claim 1, wherein the support member includes a supporting base part that is adjacent to the first bearing, and a supporting tubular part configured to project out from the supporting base part along an axial direction of the rotating shaft; and
an outer peripheral surface of the supporting tubular part supports an inner peripheral surface of the first sleeve end part of the sleeve.

3. The rotating electric machine system according to claim 2, wherein an inner peripheral surface of the supporting tubular part forms one portion of the rotor internal flow path.

4. The rotating electric machine system according to claim 1, wherein a holder member having a hollow tubular shape and configured to surround the first sleeve end part is disposed outwardly of the first sleeve end part in the radial direction; and
a seal member configured to face in the radial direction toward the holder member is disposed on an outer peripheral part of the first sleeve end part.

5. The rotating electric machine system according to claim 4, wherein the support member includes a supporting base part that is adjacent to the first bearing, and a supporting tubular part configured to project out from the supporting base part along an axial direction of the rotating shaft;
an outer peripheral surface of the supporting tubular part supports an inner peripheral surface of the first sleeve end part of the sleeve; and
a preload applying member configured to apply a load to an outer ring of the first bearing is disposed in a manner so as to surround the holder member, the seal member, and the supporting tubular part.

6. The rotating electric machine system according to claim 1, wherein the support member and the rotating shaft are fixed to each other by press fitting; and
the support member and the sleeve are fixed to each other by press fitting.

7. The rotating electric machine system according to claim 1, wherein the sleeve is shrink-fitted onto an outer surface of the rotating shaft, and is also shrink-fitted onto a magnet stopper configured to fix the permanent magnet.
